(19) United States
(12) Patent Application Publication
(10) Pub. No.: US 2025/0171101 A1
(43) Pub. Date: May 29, 2025

(54) VEHICLE AND METHOD FOR DETERMINING VEHICLE OCCUPANCY

(71) Applicant: AUTOLIV DEVELOPMENT AB, Vargarda (SE)

(72) Inventor: Shivali-Setharama GUNDIBAIL, Vargarda (SE)

(21) Appl. No.: 18/837,363

(22) PCT Filed: Feb. 2, 2023
(86) PCT No.: PCT/EP2023/052490

§ 371 Date: Aug. 9, 2024

(30) Foreign Application Priority Data
Feb. 14, 2022 (DE) 10 2022 103 359.7

(51) Int. Cl. B62J 27/20; B60L 15/20; B62J 45/41; B62L 3/00; G07C 5/00

(52) U.S. Cl. CPC B62J 27/20; B60L 15/20; B62J 45/41; B62L 3/00; B60L 2200/24; G07C 5/008

(57) ABSTRACT

A vehicle and a method for determining a vehicle's occupancy. A vehicle, comprising a passenger occupancy element for accommodating an occupant of the vehicle, the passenger occupancy element comprises at least one load determining element, wherein the load determining element is arranged to determine a weight or a weight distribution imposed by at least one occupant of the vehicle arranged on the passenger occupancy element, wherein the vehicle is adapted to determine a current occupancy situation of the vehicle, wherein the vehicle, dependent on the determined the weight or weight distribution, operate in one of at least two different modes, a first mode of operation when determined occupancy is equal to or below an occupancy threshold, and a second mode of operation when determined occupancy is exceeding the occupancy threshold, wherein an exceptional mode of operation, i.e. the second mode, is a mode of operation with reduced functionality.

### TECHNICAL FIELD

The present disclosure relates to vehicle technology. In particular, the present disclosure relates to safely operating a vehicle. Further in particular, the present disclosure relates to a vehicle and a method for determining a vehicle occupancy.

### BACKGROUND

City traffic has changed significantly over the recent years, in particular with the advent of on-demand vehicle sharing services. Especially sharing services of two-wheeled vehicles like e-scooters rose significantly with the general legalisation in various countries throughout Europe and all over the world. Such two wheeled vehicles are often used for last mile trips and thus have a high usage ratio. With the increase of users, an increase of casualties is observed. Statistics show that many crashes are so-called single vehicle crashes and as such may be mainly attributed to the driver and their behaviour when operating the vehicle.

One particular way of misuse of rented vehicles like e-scooters is operating, in particular riding, the vehicle with a number of occupants exceeding the constructional or legal maximum occupancy. E.g., common e-scooters are regularly intended for a single person riding the vehicle. While the vehicle itself may allow transport of more than one person, its construction may not be designed to accommodate more than one person. In case of a structural failure due to overload, serious harm or injury for the occupants may occur.

Furthermore, many countries where the operation of e-scooters on public roads is legally allowed have a maximum occupancy limit of one person riding the vehicle. As a consequence, operators of such a vehicle where the maximum occupancy is exceeded may thus commit an offence punishable by law. Further, a manufacturer of a vehicle may be liable or likewise punishable by law in case no technical measures are taken to prevent the operation of the vehicle with a number of occupants exceeding the allowed legal limit.

Thus, there may be a need to determine the vehicle occupancy to determine whether a maximum occupancy has been exceeded, in particular when a trip is about to commence.

Further, there may be a need to provide measures prohibiting the operation of a vehicle where it has been determined that the occupancy is exceeding the legal limit.

### SUMMARY

At least one such need may be met by the subject-matter of the independent claims. Preferred embodiments are provided in the dependent claims and are explained in detail in the following description.

The present invention relates to determining vehicle occupancy in order to allow safe operation of the vehicle.

According to a first aspect of the present disclosure, there is provided a vehicle, comprising a passenger occupancy element for accommodating an occupant of the vehicle, the passenger occupancy element comprises at least one load determining element, wherein the load determining element is arranged to determine a weight or a weight distribution imposed by at least one occupant of the vehicle arranged on the passenger occupancy element, wherein the vehicle is adapted to determine from the weight or weight distribution a current occupancy situation of the vehicle, wherein the vehicle, dependent on the determined weight or weight distribution, is arranged to operate in one of at least two different modes of operation, wherein the vehicle is operating in a first mode of operation when it is determined that the current occupancy situation is equal to or below an occupancy threshold, wherein the vehicle is operating in a second mode of operation when it is determined that the current occupancy situation is exceeding the occupancy threshold, wherein the first mode of operation is substantially a normal mode of operation, wherein the second mode of operation is an exceptional mode of operation, and wherein the exceptional mode of operation is a mode of operation with reduced functionality.

According to a second aspect of the present disclosure, there is provided a method for operating a vehicle, comprising the steps determine, by at least one load determining element, a weight or a weight distribution imposed by at least one occupant of a vehicle arranged on a passenger occupancy element of the vehicle, determine from the weight or weight distribution a current occupancy situation of the vehicle, wherein when it is determined that the current occupancy situation is equal to or below an occupancy threshold, operate the vehicle in a first mode of operation, and wherein, when it is determined that the current occupancy situation is exceeding the occupancy threshold, operate the vehicle in second mode of operation.

According to a third aspect of the present disclosure, there is provided a computer program product comprising instructions which, when the program is executed by a processing element, cause the processing element to carry out the method according to the present disclosure.

According to a fourth aspect of the present disclosure, there is provided a computer-readable storage medium comprising instructions which, when executed by a processing element, cause the processing element to carry out the method according to according to the present disclosure.

According to a fifth aspect of the disclosure, a vehicle is using the method according to the present disclosure.

According to a sixth aspect of the present disclosure, there is provided a vehicle, comprising a passenger occupancy element for accommodating an occupant of the vehicle, the passenger occupancy element comprises at least one load determining element, wherein the load determining element is arranged to determine a weight or a weight distribution imposed by at least one occupant of the vehicle arranged on the passenger occupancy element, wherein the vehicle is adapted to determine from the weight or weight distribution a current occupancy situation of the vehicle, wherein the vehicle, dependent on the determined weight or weight distribution, is arranged to operate in one of at least two different modes of operation, wherein the vehicle is operating in a first mode of operation when it is determined that the current occupancy situation is equal to or below an occupancy threshold, and wherein the vehicle is operating in a second mode of operation when it is determined that the current occupancy situation is exceeding the occupancy threshold.

One preferred way to determine the occupancy of a vehicle is to determine the load acting on the vehicle, e.g., on a passenger occupancy element. Here, the load may correspond to the weight of an occupant, or in case of a plurality of occupants of the sum of all occupants seen together. Alternatively, a load distribution acting on the passenger occupancy element may be used. E.g., in case of a vehicle that accommodates occupants or passengers standing up on the passenger occupancy element a load distribution may correspond to the contact points between the occupants and the vehicle, like the contact points between the feet of a passenger and the passenger occupancy element. Here, in case two contact points are derivable from the load distribution, it be assumed that the passenger occupancy element accommodates one passenger. In case more than two contact points are derivable from the load distribution, such may be an indication that more than one passenger is currently situated on the passenger occupancy element. E.g., four contact points being derivable from the load distribution suggest that two passengers are standing on the passenger occupancy element.

The determined contact points may thus be correlated with the usual number of contact points in accordance with e.g., a constructional or a legal limit of occupancy and in case it is determined that the number of contact points is exceeding the usual number of contact points it may be concluded that the current occupancy situation is one that is not permitted. In other words, an occupancy situation is determined from the weight or weight distribution with the occupancy situation essentially corresponding to a number of occupants or passengers currently occupying the vehicle. The technical or legal limitations of the vehicle define an occupancy threshold were in other words if in a number of allowed passengers. A current occupancy situation may thus be below or equal to said occupancy threshold or alternatively may exceed the occupancy threshold. In case the occupancy situation is below or equal to the occupancy threshold, the number of current occupants of the vehicle, e.g., situated on the passenger occupancy element is still within the constructional or legal limits. E.g., in case the determined occupancy situation is one passenger, and the occupancy threshold is likewise one passenger, the occupancy situation is equal to the occupancy threshold corresponding to a situation where the constructional or legal limits are met. In case the determined occupancy situation is exceeding the occupancy threshold, e.g., in case the occupancy situation is determined to be two passengers while the occupancy threshold still is one passenger, the occupancy situation is such that the constructional or legal limits are not met any more.

The weight distribution may, additionally or alternatively, also reflect the size of a certain contact point between the passenger and the passenger occupancy element. E.g., in case the contact point is unusually large, it may be deduced that the contact point is actually corresponding to two feet close together instead of one foot. In this case, even if the number of contact points is only two, in case the contact points in turn are unusually large, it may be deduced that the occupancy situation still corresponds to two passengers, with their respective feet close together. Here, in particular with regard to an e-scooter application, the feet close together may belong to the same passenger, having a small stance or may belong to both passengers having a larger stance and in particular standing with one foot close to the foot of the other passenger. In any case, it may be determined that the occupancy situation is such that it exceeds the occupancy threshold.

Dependent on the occupancy threshold, i.e., based on the determination of a number of passengers and whether said number is complying with or exceeding the legal or constructional limits of the vehicle, the vehicle may operate in different modes.

The weight or weight distribution may be determined by suitable measuring elements, e.g., load cells, arranged on or in the passenger occupancy element so to detect the weight of passengers accommodating the passenger occupancy element. Preferably, the load cells may be placed spaced evenly across the passenger occupancy element, thereby allowing the determination of a certain weight on a certain area of the passenger occupancy element. From their respective weight in a certain area of the passenger occupancy element, a weight distribution may be determined. This also allows to distinguish between an occupancy situation where one person has a certain amount of weight versus an occupancy situation where more than one person has that certain amount of weight, e.g., a situation where a single person weighs 80 kg versus an occupancy situation where two persons weigh 80 kg together.

Additionally, or alternatively to determining whether an occupancy situation exceeds a defined occupancy threshold, the weight and in particular the weight distribution be used to determine whether an occupant has assumed a preferable position, e.g., a preferable standing position, on the passenger occupancy element. Feedback may be given to the occupant in case a non-preferable position is determined, to motivate the occupant to change the position to a preferable position. E.g., the occupant may assume a position that unbalances the vehicle and may thus be directed by the feedback to assume a position where the vehicle is more balanced.

Determining whether a current occupancy situation is equal to or below, or alternatively exceeding an occupancy threshold, may increase the safety of the passenger and the safe operation of the vehicle by informing the passenger accordingly, to change the occupancy situation to an allowed occupancy situation, or only allow to operate the vehicle only when an allowed occupancy situation is determined. Also, a company renting the vehicle to passengers may benefit from increased revenue in case it can be assured that a vehicle can only be operated with the maximum allowed number of occupants.

According to an embodiment of the present disclosure, the first mode of operation may be substantially a normal mode of operation, and the second mode of operation may be an exceptional mode of operation, in particular a mode of operation with reduced functionality.

According to a further embodiment of the present disclosure, the second mode of operation may comprise limiting the maximum speed of the vehicle, in particular to a speed below the maximum speed in the first mode of operation.

Once the occupancy situation has been determined, it can be deduced whether the current occupancy is complying with or exceeding a defined occupancy threshold. In case it is determined that the occupancy situation is complying with the occupancy threshold, the normal mode of operation of the vehicle may be made available to the occupant operating the vehicle. In this mode of operation, the vehicle may be operated substantially normal, e.g., with the maximum allowed functionality offered by the vehicle is intended by the manufacturer of the vehicle. E.g., the vehicle may be allowed to travel at speeds up to its maximum allowed speed, freely chosen by the occupant. Likewise, the occupant may choose any allowed path to operate the vehicle. Contrary hereto, in case it is determined that the occupancy situation is exceeding an allowed occupancy threshold, operation of the vehicle may be limited. In this case, a maximum allowed speed of the vehicle may be reduced so that the occupants may operate the vehicle only at a lower maximum speed. This reduced speed, or this reduced maximum speed, may be maintained until it is determined that the occupancy situation again is equal to or below the allowed occupancy threshold.

E.g., in case an occupant commences a trip where the current occupancy situation is complying with the occupancy threshold, i.e., is below or equal to the occupancy threshold, but subsequently, the occupancy situation is changed so not comply with the occupancy threshold anymore, i.e., is now exceeding the occupancy threshold, the vehicle may switch from the first mode of operation to the second mode of operation. E.g., in case an additional occupant is mounting the vehicle after a trip has been commenced, such may exceed the occupancy threshold during an ongoing operation. The vehicle may still determine said non-compliance with the occupancy threshold and may subsequently switch the mode of operation of the vehicle to the second mode of operation.

In the second mode of operation, a possible path taken by the vehicle may be limited to a path that substantially takes the vehicle to a specific location on the shortest path without allowing any substantial deviation from said path. Minor deviations, e.g., from steering or the like may of course be allowed. It is also conceivable to allow the returning on said shortest path only with a reduced maximum velocity.

According to a further embodiment of the present disclosure, in the second mode of operation an emergency braking function of the vehicle may be activated to bring the vehicle to a controlled and/or complete stop, and/or in the second mode of operation the vehicle may not be activated.

In other words, in case the vehicle determines a non-compliance with the occupancy threshold, the vehicle may be brought to a controlled stop, in particular without risking injuring the occupants of the vehicle. Once the vehicle has been brought to a controlled stop, any subsequent activation of the vehicle may be prohibited. The activation may be prohibited until the manufacturer or a further entity again releases the vehicle or alternatively the activation may be prohibited until an again compliance with the occupancy threshold is determined. Requiring a further entity to release the vehicle may further discourage the use of the vehicle with an occupancy situation exceeding the occupancy threshold. E.g., in case of a rented vehicle, the rental agency may require the passenger to contact and explain why the vehicle is in the second mode of operation. After that, the vehicle may be released, and in particular returned only in a released state. Thereby, the passenger is required to justify themselves why the vehicle is in the second mode of operation before they may return the vehicle, i.e., before the charging of the rental is stopped.

According to a further embodiment of the present disclosure, the vehicle may further comprise an indicator element, wherein the indicator element may be arranged to be activated in the second mode of operation, in particular the indicator element may be at least one element out of the group consisting of a light, a head light, a handle light, a brake light, a turn light, a vibration element, a sound emitting element and a display.

By using an according indicator element to indicate the non-compliance with the occupancy threshold, the operator of the vehicle and/or third parties in the vicinity of the heater may be made aware of the exceeding of the occupancy threshold. The indicator element may be activated once the vehicle is in the second mode of operation or may be used to indicate that the vehicle is about to switch to the second mode of operation, e.g., while also indicating the time the vehicle switches to the second mode of operation. The indication of the time may be with countdown or the like so that the occupant may take measures to reverse the non-compliance with the occupancy threshold. E.g., the vehicle may indicate to the operator that the vehicle is about to switch to the second mode of operation in 10 seconds, thereby allowing the operator to re-establish compliance with the occupancy threshold, e.g., by allowing a further occupant to disembark in thereby avoiding the switching of the vehicle into the second mode of operation.

According to a further embodiment of the present disclosure, the vehicle may further comprise an airbag element, and the airbag element may be adapted to be inactivated in the second mode of operation.

An airbag element may normally be adapted to a specific occupancy situation. It is thus conceivable that in a specific occupancy situation exceeding the occupancy threshold, i.e., which constitutes an occupancy situation for which the airbag element is not designed, the airbag element may not provide sufficient protection any more in order to avoid injury and/or possibly additional injury to the occupant/occupants, it may be preferable to deactivate the airbag element. In case the airbag element would be activated in an accident situation even when the occupancy threshold is exceeded, the company re-factoring the airbag and/or the vehicle manufacturer may be liable in case of injury due to the airbag not providing sufficient protection. It may first be preferable to clearly communicate with an occupant that in case the occupancy situation is exceeded, provided airbag elements will not be activated. It may thus be in the responsibility of occupant/operator of the vehicle to assure that the occupancy threshold is not exceeded in order to maintain the protection function of the airbag element.

According to a further embodiment of the present disclosure, the vehicle may further comprise a communication element, the communication element may be adapted to communicate with a remote entity and may be adapted to communicate to the remote entity the operation of the vehicle in the second mode of operation.

Once it is determined that the vehicle is operating or is about to operate in the second mode of operation, said event may be communicated to a remote entity. The remote entity may e.g., be the manufacturer of the vehicle, a rental agency, emergency medical services and or the authorities. The remote entity may subsequently respond to the second mode of operation appropriately, e.g., by sanctioning the operator of the vehicle. The communication element may be adapted to further communicate a position of the vehicle, in particular a current and/or life position of the vehicle to the third entity. The position may be determined using a global positioning system like GALILEO, GPS or GLONASS, so that the vehicle may be found by the third entity even in case the operator continues to operate the vehicle in the second mode of operation.

According to a further embodiment of the present disclosure, a notification may be sent from the vehicle and/or the remote entity to a mobile computing device of a passenger of the vehicle in case the vehicle is operating in the second mode of operation.

E.g., the operator or occupant of the vehicle may have a mobile computing device that is associated with the occupant/operator, e.g., used for renting the vehicle. The renting may be performed by a dedicated app on the mobile computing device and the notification may be sent to or communicated by the mobile app. Alternatively or additionally, the mobile app may retain a history of instances where the second mode of operation has been activated, i.e., where the occupancy threshold has been exceeded. In case a further threshold has been exceeded, e.g., a threshold within the application on the mobile computing device, the application may prevent the further renting of vehicles.

Alternatively, the notification may take over the functionality of the indicator element in order to inform the occupant/operator of the vehicle that the occupancy threshold was exceeded. Still further, the notification may trigger an information to the occupant/operator regarding the immediate and/or future consequences of said exceeding the occupancy threshold. E.g., the operator may be notified that a surcharge will be debited for the current trip due to the exceeding of the occupancy threshold e.g., an additional insurance surcharge. Additionally, or alternatively, the operator may be notified that they will not be able to rent another vehicle for a defined period of time, e.g., for another hour, for another day or for another month et cetera.

According to a further embodiment of the present disclosure, the method may further comprise at least one of the following steps when in the second mode of operation, limiting the maximum speed of the vehicle, in particular to a speed below the maximum speed in the first mode of operation, activate an emergency braking function if the vehicle is activated to bring the vehicle to a controlled and/or complete stop, deactivate the vehicle, prohibit activation of the vehicle, activate an indicator element and deactivate an airbag element.

According to a further embodiment of the present disclosure, the method may further comprise at least one of the following steps when in the second mode of operation, communicate with a remote entity to indicate the operation of the vehicle in the second mode of operation, and send a notification from the vehicle and/or a remote entity to a mobile computing device of a passenger of the vehicle in case the vehicle is operating in the second mode of operation.

### BRIEF DESCRIPTION OF THE DRAWINGS

The present invention will now be described with reference to the accompanying drawings, in which:

FIG. 1 shows an embodiment of a first application scenario according to the present disclosure.

FIGS. 2A,B shows an embodiment of details of a vehicle according to the present disclosure.

FIGS. 3A,B show an embodiment of a second application scenario according to the present disclosure.

### DETAILED DESCRIPTION

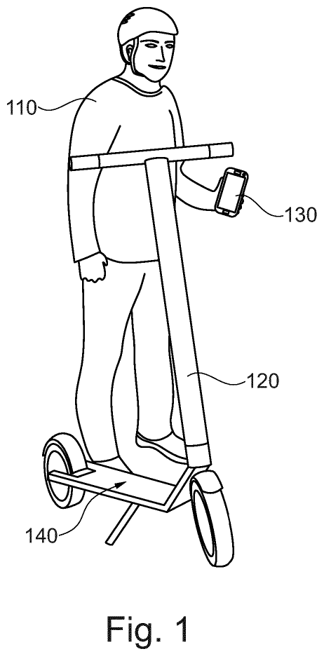

Now referring to FIG. 1, where an embodiment of an overview of an application scenario according to the present disclosure is shown.

FIG. 1 shows a person 110 standing next to a vehicle 120. The vehicle 120 is exemplarily depicted as an e-scooter (also known as electro-kick-scooter or kick board), however any type of vehicle is conceivable. Person 110 is holding a mobile device 130, e.g., a mobile phone or smart phone and is about to rent the vehicle 120, e.g., for a short trip in an urban environment. The renting of the vehicle 120 may in particular be conducted as known in the art. Once the vehicle 120 is rented, person 110 may commence a trip and disembark with the vehicle 120. In order to accommodate the person 110 in the course of the trip, the vehicle 120 comprises a passenger occupancy element 140. In FIG. 1, the passenger occupancy element 140 is a substantially flat platform on which surface the person 110 may stand on while the vehicle 120 is moving. After renting the vehicle 120, person 110 may mount the vehicle 120 and may commence the trip. Once person 110 has mounted the vehicle 120, the person 110 becomes an occupant, passenger and/or operator 110 of the vehicle 120.

The vehicle 120 depicted in FIG. 1, an e-scooter, regularly has an occupancy limit of one occupant. In other words, said occupancy of one corresponds to the maximum occupancy allowed due to constructional or legal limits. In this case, the occupancy threshold corresponds to said “one person”. In case person 110 has mounted vehicle 120 and commences the trip, the occupancy of one person corresponds to the current occupancy situation. In the example of FIG. 1, the occupancy situation is thus one person while the occupancy threshold is equally one person, resulting in that the current occupancy situation is equal to the occupancy threshold. In this situation where the vehicle 120 has one occupant 110, the vehicle would thus be operating in the first mode of operation, i.e., within the constructional or legal limits. In case a second person, in the example of FIG. 1, would additionally mount the passenger occupancy element 140, and thus result in two occupants 110 both arranged on the passenger occupancy element 140, the current occupancy situation would be said two persons, while the occupancy threshold still would be one person. In this case, since the current occupancy situation exceeds the occupancy threshold, the vehicle 120 would thus switch and operate in the second mode of operation.

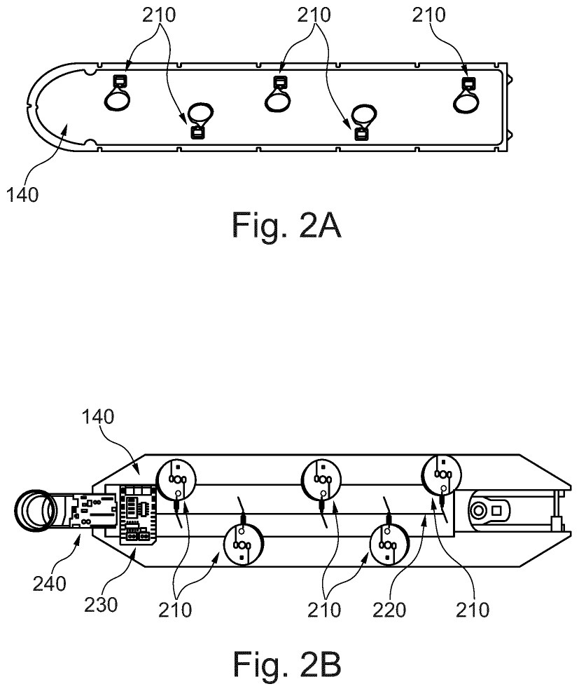

Now referring to FIGS. 2A,B, where an embodiment of details of a vehicle according to the present disclosure is shown.

In order to determine a current occupancy situation, the passenger occupancy element 140 comprises a plurality of load determining elements 210, arranged at select points across the surface of the occupancy element 140. The load determining elements 210 may be embedded into the interior of the passenger occupancy element 140, thereby possibly not been visible from the outside. Alternatively, the passenger occupancy element may comprise openings to accommodate the load determining elements 210, which thus may be accessible from the outside. Each load determining element 210 may determine a load, e.g., a (part of a) weigh of a person standing on the passenger occupancy element 140. The load may be determined directly by the load determining element 210, e.g., when a person is standing on the respective floor determining elements 210, or alternatively the load determining element 210 may register a deformation of the passenger occupancy element 140, e.g., a twisting or flexing of the passenger occupancy element 140, due to a person standing on the passenger occupancy element.

Embedding the load determining elements 210 within the passenger occupancy element 140 provides additional protection for the load determining element 210 from external forces or environmental hazards or harsh conditions, e.g., rain or snow. The load determining elements 210 are spaced appropriately, so to be able to monitor substantially the complete passenger occupancy element 140 with regard to a load acting on it. Each passenger occupancy element 210 may register an individual load in a dedicated subsection of the passenger occupancy element as an individual measurement value, e.g., a load value. In other words, each load determining element may register a load or value independent of other load determining elements. By using and in particular appropriately processing the individual measurement values, a load distribution acting on the surface of the passenger occupancy element 140 may be determined. A load distribution in turn may allow a finer determination of loads acting on the surface of the passenger occupancy element 140 compared to analysing the signals of the load determining elements 210 independent from one another.

E.g., in case it is determined that a significant load is acting on both the two rightmost and two leftmost load determining elements 210 as depicted in FIGS. 2A,B, while little or no load is acting on the central load determining element 210, it may be deduced that an occupant standing on the passenger occupancy element 140 is standing with one foot adjacent to the two leftmost load determining elements 210 and with the other foot adjacent to the two rightmost load determining elements 210. The occupant has thus contact with the passenger occupancy element via two contact points, corresponding to the two feet. In such a measurement scenario, it may thus be deduced that only a single occupant is occupying the vehicle and thus the current occupancy situation equals the occupancy threshold. Consequently, since the current occupancy situation is equal to the occupancy threshold, the vehicle may be operated in the first mode of operation.

In addition to the weight or weight distribution, also a total weight value may be used to determine the current occupancy situation. In this scenario, in case the determined weight is exceeding the maximum weight capacity of the vehicle, such may also result in the determination that the occupancy threshold is exceeded. E.g., the occupancy threshold may be 120 kg. Said value may e.g., correspond to the constructional capacity of the vehicle. In case it is determined that the current occupancy situation is below or equal to said occupancy threshold, the vehicle may be operated in the first mode of operation. In case it is determined that the current weight acting on the vehicle via the passenger occupancy element is exceeding said 120 kg, the occupancy threshold may be considered to be for exceeded in this case as well.

FIG. 2B provides a more detailed overview of the electrical system connecting the load determining elements 140. Again, the passenger occupancy element 140 comprises exemplarily five load determining element 210, arranged in a staggered formation. The load determining elements 110 are connected by a connection 220, in particular electrically connected. Connection 220 may be a serial or parallel bus connection, and likewise, the load determining elements 210 may be connected in serial or parallel. Connection 220 may transport data signals from the load determining elements 210, and may additionally provide energy to the load determining elements 210, in which case they are active elements requiring an external power feed. The load determining elements 210 in the exemplary embodiment of FIG. 2B are connected to an analogue to digital converter 230, which in turn is connected to a processing element 240. The measurement signals generated by the load determining elements 210 are thus sent to the analogue to digital converter 230, where they are converted into digital signals and communicated to the processing element 240 for analysis. Processing element 240 analyses the signals, in particular weight values acquired by the load determining element 210. From the individual acquired signals, processing element 240 may determine absolute weight values and/or a weight distribution across the surface of the passenger occupancy element 140.

Not depicted in FIG. 2B, processing element 240 may also comprise a communication element to communicate with further entities. The communication may in particular be wireless communication, e.g., near field communication to a device arranged in the vicinity of the vehicle 110 or may be far field communication. Near field communication may exemplarily be Bluetooth or Wi-Fi communication, whereas far field communication may be communication using a cellular network like 3G, LTE, 5G or LoRaWan. The communication element may in particular enable processing element 240 to connect to a global communication network, like the Internet. The processing element may further be arranged to control additional elements like an indicator element or an airbag element, both of which are not depicted in FIG. 2B.

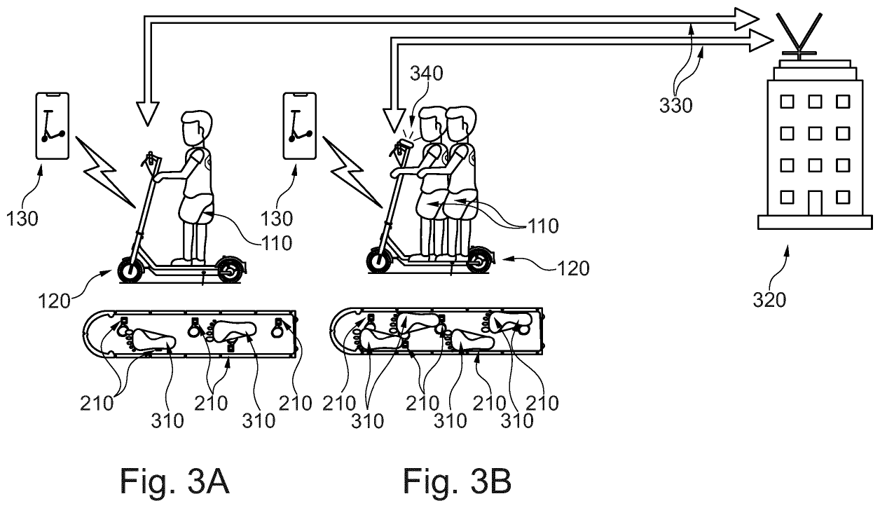

Now referring to FIGS. 3A,B, where an embodiment of a second application scenario according to the present disclosure is shown.

FIG. 3A exemplarily depicts a scenario where the current occupancy situation is equal to or below an occupancy threshold while FIG. 3B exemplary depicts a scenario where the current occupancy situation exceeds the occupancy threshold of the vehicle 120.

In FIG. 3A, a single occupant 110 is situated on the passenger occupancy element 140. As can be seen, the occupant 110 stands with both feet on the passenger occupancy element 140 and thus, each foot corresponds to a contact point 310 on the surface of the passenger occupancy element 140. From the detected weight values and thus the calculated weight distribution on the passenger occupancy element 140, the vehicle, in particular its processing element may determine that the occupant 110 is complying with the occupancy threshold. The vehicle 120 may thus be operated in the first mode of operation, in the essentially regular or normal mode of operation. The vehicle 120 may communicate to a mobile device 140 details about the trip, in particular may communicate that the vehicle is operating in the first mode of operation. The operation in the first mode of operation may thus be logged with the mobile device 140. Alternatively, or additionally, the vehicle 120 may communicate 330 with a remote entity 320 and may in particular inform the remote entity 320 that the vehicle 120 is operating in the first mode of operation, where the occupant 110 is complying with constructional and/or legal limit.

In FIG. 3B, exemplarily two occupants 110 are arranged on the passenger occupancy element 140. In the scenario of an e-scooter, having two occupants 110 arranged on the passenger occupancy element 140 may correspond to a current occupancy situation that is exceeding the occupancy threshold of one person. In order to detect that the occupancy situation is such that it exceeds the occupancy threshold of the vehicle, the load determining elements 210 of the passenger occupancy element 140 are detecting a load/load distribution corresponding to an occupancy situation with two occupants 110. In particular, two occupants 110 standing on the passenger occupancy element 140 results in a total of four contact points 310 between the respective feet of the occupants 110 and the passenger occupancy element 140. The processing element of the vehicle 120 may thus determine from the load measurements a load distribution and thus from the number of contact points 310, that the current occupancy situation cannot correspond to an occupancy situation where only a single occupant 110 is situated on the passenger occupancy element 140. Once the processing element has determined that the current occupancy situation is such that it exceeds the occupancy threshold, the vehicle 120 may be put into the second mode of operation, e.g., by the processing element.

In the second mode of operation, the maximum possible speed of the vehicle may be limited to a crawling speed, the vehicle may be brought to a controlled stop and/or an activation, i.e., a commencement of a trip, may be prohibited, e.g., by deactivation of a motor element normally used for driving the vehicle 120. The result of the detection that the current occupancy situation is exceeding the occupancy threshold may be communicated to a mobile device 130, where it can be logged. Alternatively, or additionally, the determination of exceeding the occupancy threshold may be communicated 330 to the remote entity 320. Remote entity 320 may in turn initiate measures, e.g., may remote control or send remote instructions to the vehicle 120. An indicator element 340 may signal to the occupants 110 that an exceeding of the occupancy threshold has been detected. E.g., indicator element 340 may be a display, lamp or LED that illuminates or changes colour when the exceeding of the occupancy threshold is detected. The indicator element 340 may be activated by the vehicle 120, in particular by the processing element of the vehicle, and/or may be activated by the remote entity 320. The indicator element 340 may be used to communicate with the occupants of the vehicle, e.g., by displaying a human readable message. E.g., it may be signalled to the occupants of the vehicle to resolve that the occupancy situation is exceeding the occupancy threshold within a defined time limit, e.g., within 10 seconds, 30 seconds or one minute, as otherwise measures will be initiated to deactivate the vehicle. Once the exceeding of the occupancy threshold has been resolved, i.e., the occupancy situation is again such that the occupancy threshold is complied with, the remaining occupant 110 may continue the trip, as depicted in FIG. 3A.

It is to be understood that the invention is not limited to the embodiments described above, and various modifications and improvements may be made without deviating from the concepts described here. Any of the features described above and below may be used separately or in combination with any other features described herein, provided they are not mutually exclusive, and the disclosure extends to and includes all combinations and sub-combinations of one or more features described herein.

Finally, it should be noted that the term “comprising” not exclude other elements or steps, and that “a” or “one” does not exclude the plural. Elements that are described in relation to different types of embodiments can be combined. Reference signs in the claims shall not be construed as limiting the scope of a claim.

### LIST OF REFERENCE NUMERALS

110 person/occupant/passenger/operator
120 vehicle
130 mobile device
140 passenger occupancy element
210 load determining element
220 connection
230 analogue digital converter/ADC
240 processing element/μP
310 contact point
320 entity
330 communication connection
340 indicator element

1-13. (canceled)

14. A vehicle, comprising:
a passenger occupancy element for accommodating an occupant of the vehicle, the passenger occupancy element comprises at least one load determining element;
wherein the load determining element is arranged to determine a weight or a weight distribution imposed by at least one occupant of the vehicle arranged on the passenger occupancy element,
wherein the vehicle is adapted to determine from the weight or weight distribution a current occupancy situation of the vehicle,
wherein the vehicle, dependent on the determined weight or weight distribution, is arranged to operate in one of at least two different modes of operation,
wherein the vehicle is operating in a first mode of operation when it is determined that the current occupancy situation is equal to or below an occupancy threshold,
wherein the vehicle is operating in a second mode of operation when it is determined that the current occupancy situation is exceeding the occupancy threshold,
wherein the first mode of operation is substantially a normal mode of operation,
wherein the second mode of operation is an exceptional mode of operation, and
wherein the exceptional mode of operation is a mode of operation with reduced functionality,
wherein the vehicle is a two-wheeled vehicle, and
wherein the passenger occupancy element is arranged and configured to accommodate at least one occupant in a standing manner.

15. The vehicle according to claim 14, wherein the second mode of operation comprises limiting the maximum speed of the vehicle, in particular to a speed below the maximum speed in the first mode of operation.

16. The vehicle according to claim 14, wherein in the second mode of operation an emergency braking function of the vehicle is activated to bring the vehicle to a controlled and/or complete stop, and/or wherein in the second mode of operation the vehicle cannot be activated.

17. The vehicle according to claim 14, further comprising an indicator element,
wherein the indicator element is arranged to be activated in the second mode of operation, in particular wherein the indicator element is at least one element out of the group consisting of a light, a head light, a handle light, a brake light, a turn light, a vibration element, a sound emitting element and a display.

18. The vehicle according to claim 14, wherein the passenger occupancy element comprises at least two load determining elements, and wherein the load determining elements are arranged to determine the weight distribution imposed by at least one occupant of the vehicle arranged on the passenger occupancy element.

19. The vehicle according to claim 14, further comprising
an airbag element,
wherein the airbag element is adapted to be inactivated in the second mode of operation.

20. A vehicle, comprising:
a passenger occupancy element for accommodating an occupant of the vehicle, the passenger occupancy element comprises at least one load determining element;
wherein the load determining element is arranged to determine a weight or a weight distribution imposed by at least one occupant of the vehicle arranged on the passenger occupancy element,
wherein the vehicle is adapted to determine from the weight or weight distribution a current occupancy situation of the vehicle,
wherein the vehicle, dependent on the determined weight or weight distribution, is arranged to operate in one of at least two different modes of operation,
wherein the vehicle is operating in a first mode of operation when it is determined that the current occupancy situation is equal to or below an occupancy threshold,
wherein the vehicle is operating in a second mode of operation when it is determined that the current occupancy situation is exceeding the occupancy threshold,
wherein the first mode of operation is substantially a normal mode of operation,
wherein the second mode of operation is an exceptional mode of operation, and
wherein the exceptional mode of operation is a mode of operation with reduced functionality,
the vehicle further comprising:
a communication element,
wherein the communication element is adapted to communicate with a remote entity, and
wherein the communication element is adapted to communicate to the remote entity the operation of the vehicle in the second mode of operation.

21. A vehicle, comprising:
a passenger occupancy element for accommodating an occupant of the vehicle, the passenger occupancy element comprises at least one load determining element;
wherein the load determining element is arranged to determine a weight or a weight distribution imposed by at least one occupant of the vehicle arranged on the passenger occupancy element,
wherein the vehicle is adapted to determine from the weight or weight distribution a current occupancy situation of the vehicle,
wherein the vehicle, dependent on the determined weight or weight distribution, is arranged to operate in one of at least two different modes of operation,
wherein the vehicle is operating in a first mode of operation when it is determined that the current occupancy situation is equal to or below an occupancy threshold,
wherein the vehicle is operating in a second mode of operation when it is determined that the current occupancy situation is exceeding the occupancy threshold,
wherein the first mode of operation is substantially a normal mode of operation,
wherein the second mode of operation is an exceptional mode of operation,
wherein the exceptional mode of operation is a mode of operation with reduced functionality, and
wherein a notification is sent from the vehicle and/or the remote entity to a mobile computing device of a passenger of the vehicle in case the vehicle is operating in the second mode of operation.

22. A method for operating a vehicle, comprising the steps of:
determine, by at least one load determining element, a weight or a weight distribution imposed by at least one occupant of a vehicle arranged on a passenger occupancy element of the vehicle,
determine from the weight or weight distribution a current occupancy situation of the vehicle,
wherein when it is determined that the current occupancy situation is equal to or below an occupancy threshold, operate the vehicle in a first mode of operation, and
wherein, when it is determined that the current occupancy situation is exceeding the occupancy threshold, operate the vehicle in second first mode of operation,
wherein the first mode of operation is substantially a normal mode of operation,
wherein the second mode of operation is an exceptional mode of operation, and
wherein the exceptional mode of operation is a mode of operation with reduced functionality,
the method comprising at least one of the following steps when in the second mode of operation,
communicate with a remote entity to indicate the operation of the vehicle in the second mode of operation, and
send a notification from the vehicle and/or a remote entity to a mobile computing device of a passenger of the vehicle in case the vehicle is operating in the second mode of operation.

23. The method according to according to claim 22, the method comprising at least one of the following steps when in the second mode of operation:
limiting the maximum speed of the vehicle, in particular to a speed below the maximum speed in the first mode of operation,
activate an emergency braking function if the vehicle is activated to bring the vehicle to a controlled and/or complete stop,
deactivate the vehicle,
prohibit activation of the vehicle,
activate an indicator element, and
deactivate an airbag element.

24. A computer program product comprising instructions which, when the program is executed by a processing element, cause the processing element to carry out the method according to claim 23.

25. A computer-readable storage medium comprising instructions which, when executed by a processing element, cause the processing element to carry out the method according to claim 23.

26. The vehicle according to claim 14, further comprising a processing element,
wherein the processing element is arranged to carry out a method of operating a vehicle, comprising the steps of:
determine, by at least one load determining element, a weight or a weight distribution imposed by at least one occupant of a vehicle arranged on a passenger occupancy element of the vehicle,
determine from the weight or weight distribution a current occupancy situation of the vehicle,
wherein when it is determined that the current occupancy situation is equal to or below an occupancy threshold, operate the vehicle in a first mode of operation, and
wherein, when it is determined that the current occupancy situation is exceeding the occupancy threshold, operate the vehicle in second first mode of operation,
wherein the first mode of operation is substantially a normal mode of operation,
wherein the second mode of operation is an exceptional mode of operation, and
wherein the exceptional mode of operation is a mode of operation with reduced functionality,
the method comprising at least one of the following steps when in the second mode of operation,
communicate with a remote entity to indicate the operation of the vehicle in the second mode of operation, and
send a notification from the vehicle and/or a remote entity to a mobile computing device of a passenger of the vehicle in case the vehicle is operating in the second mode of operation.
